(19) United States
(12) Patent Application Publication
(10) Pub. No.: US 2017/0229939 A1
(43) Pub. Date: Aug. 10, 2017

(54) Power Supply Including An Electric Fan with Wind Power Generating Function

(71) Applicants: Chun-Ying Cheng, Taoyuan City (TW); Jung-Chien Cheng, Taoyuan City (TW)

(72) Inventors: Chun-Ying Cheng, Taoyuan City (TW); Jung-Chien Cheng, Taoyuan City (TW)

(21) Appl. No.: 15/016,316

(22) Filed: Feb. 5, 2016

(51) Int. Cl. H02K 7/18; F04D 25/06; F03D 9/00

(52) U.S. Cl. CPC H02K 7/1823; F03D 9/002; F04D 25/0613; F05B 2220/706; H02K 53/00

(57) ABSTRACT

A power supply includes a housing having a compartment. An electric motor includes a fixed seat fixed to a first end wall of the housing and located in the compartment. The electric motor further includes a shaft rotatably mounted to the fixed seat. The electric motor further includes a first stator fixed on the fixed seat and a first rotor fixed to the shaft. A first fan is fixed to the shaft. A generator is concentrically mounted around the electric motor. The generator includes a second stator fixed to the fixed seat and a second rotor rotatably mounted to the shaft and concentric to the second stator. A second fan is fixed around the second rotor. The first and second fans are coaxial and adjacent to each other. A power device is mounted to the housing and is electrically connected to the generator and the electric motor.

### BACKGROUND OF THE INVENTION

The present invention relates to a power supply and, more particularly, to a power supply including an electric fan with a wind power generating function.

With continuous improvement in development and applications of technologies, illuminating equipment, 3C products, and small household electrical appliances (such as electric lamps, televisions, electric fans, mobile phones, tablet computers, personal digital assistants, etc.) have become necessary electrical and electronic products in daily lives.

These electrical and electronic products mainly depend on internal cells or external power sources to maintain normal operation. Mobile chargers (or mobile power banks) and combustion generators have been available on the market. Most of the mobile chargers use batteries as the power sources to permit users to continuously use the electrical and electronic products and charge the electrical and electronic products at any time and place.

However, these combustion generators and mobile chargers still require fueling or charging in advance and cannot provide the power by themselves. Furthermore, these combustion generators and mobile chargers continuously consume the fuel or electricity when carried and used outside, such that the users cannot find any other power supplies when the power is run out. Thus, it is an important issue to persons in this field.

### BRIEF SUMMARY OF THE INVENTION

A power supply according to the present invention includes a housing having a first end wall, a second end wall, and a peripheral wall interconnected between the first and second end walls, defining a compartment therebetween. An electric motor includes a fixed seat fixed to the first end wall and located in the compartment. The electric motor further includes a shaft extending perpendicularly to and rotatably mounted to the fixed seat. The electric motor further includes a first stator fixed on the fixed seat and a first rotor fixed to the shaft. The first stator and the first rotor are concentrically mounted around the shaft. A first fan is fixed to the shaft. The first fan is located adjacent to the second end wall and faces the first end wall. A generator is concentrically mounted around the electric motor. The generator includes a second stator fixed to the fixed seat and a second rotor rotatably mounted to the shaft and concentric to the second stator. A second fan is fixed around the second rotor. The second fan is located adjacent to the first end wall and faces the second end wall. The first and second fans are coaxial, opposite to each other, and adjacent to each other. A power device is mounted to the housing and is electrically connected to the generator and the electric motor. The power device is adapted to supply electricity to an outside.

When the electric motor is supplied with electricity from the power device and operates, the first rotor and the shaft of the electric motor drive the first fan to rotate, generating wind power close to the second fan. The second fan is driven to rotate by the wind power in the compartment of the housing. The second fan drives the second rotor of the generator to rotate, making the generator continuously generate and supply electricity to the power device and the electric motor, thereby keeping the electric motor running. The power device is adapted to output electricity to an external electrical appliance.

In a first example, the first rotor of the electric motor is located around and spaced from the first stator. A first stator seat extends upwards from an intermediate portion of the fixed seat and has an axial hole. The shaft rotatably extends through the axial hole. The first stator is fixed around the first stator seat. A first rotor seat is fixed around the first rotor. The first rotor seat includes an end fixed to the shaft. The second rotor of the generator is located around and spaced from the second stator. A second stator seat extends upwards from the fixed seat and extends around and is spaced from the first rotor. The second stator is fixed around the second stator seat. A second rotor seat is fixed around the second rotor. The second rotor seat includes an end rotatably mounted to the shaft. The second fan is fixed around the second rotor seat.

In a second example, the first stator of the electric motor is located around and spaced from the first rotor. An axle extends upwards from an intermediate portion of the fixed seat. A first rotor seat is fixed to an inner periphery of the first rotor. The first rotor seat includes an end fixed to the shaft. The first rotor seat further includes an axial hole extending downwards and rotatably receiving the axle. A first stator seat extends upwards from the fixed seat. The first stator is fixed to an inner periphery of the first stator seat. The second rotor of the generator is located around and spaced from the second stator. The second stator is fixed around the first stator seat. A second rotor seat is fixed around the second rotor. The second rotor seat has an end rotatably mounted to the shaft. The second fan is fixed around the second rotor seat.

In a third example, the second stator of the generator is located around and spaced from the second rotor. A second stator seat extends upwards from the fixed seat. The second stator is fixed to an inner periphery of the second stator seat. A second rotor seat is fixed to an inner periphery of the second rotor. The second rotor seat includes an end rotatably connected to the shaft. A cylindrical portion extends outwards from the end of the second rotor seat and surrounds the second stator seat. The second fan is fixed around the cylindrical portion of the second rotor seat.

The housing can include an outer periphery providing a sealed member and can include at least one vent in the first end wall.

The power device can include a charging controller, a rechargeable battery, and a voltage boost circuit. The charging controller is electrically connected to the generator and the rechargeable battery. The rechargeable battery is electrically connected to the electric motor and the voltage boost circuit. The voltage boost circuit is adapted to be electrically connected to the external electrical appliance.

The housing can include a casing at a bottom side of the first end wall. The casing includes a vent. The power device is mounted in the casing.

The present invention will become clearer in light of the following detailed description of illustrative embodiments of this invention described in connection with the drawings.

### DESCRIPTION OF THE DRAWINGS

FIG. 1 is a diagrammatic cross sectional view of a power supply of a first example according to the present invention.

FIG. 2 is a block diagram of the power supply of FIG. 1.

FIG. 3 is a diagrammatic cross sectional view of a power supply of a second example according to the present invention.

FIG. 4 is a diagrammatic cross sectional view of a power supply of a third example according to the present invention.

### DETAILED DESCRIPTION OF THE INVENTION

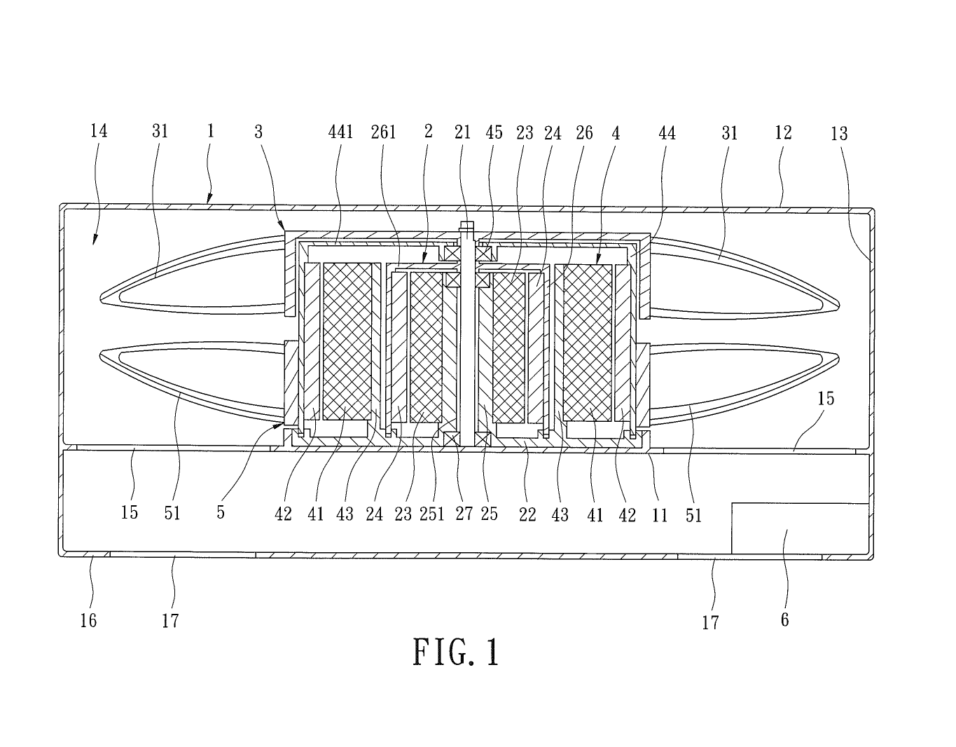

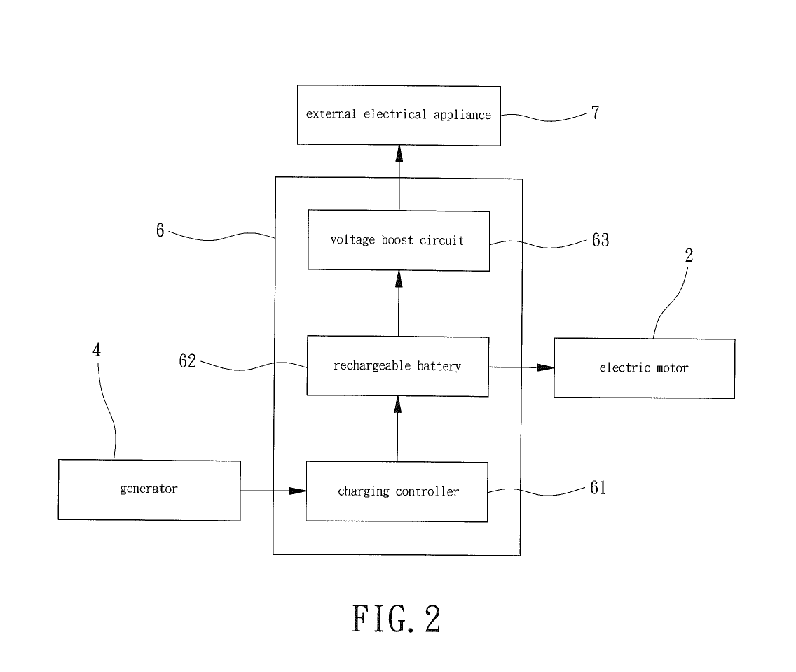

FIGS. 1 and 2 show a power supply including an electric fan with a wind power generating function of a first example according to the present invention. The power supply includes a housing 1, an electric motor 2, a first fan 3, a generator 4, a second fan 5, and a power device 6 and is adapted to continuously and stably provide electricity to an external electrical appliance 7.

The housing 1 includes a first end wall 11, a second end wall 12 opposite to the first end wall 11, and a peripheral wall 13 interconnected between the first and second end walls 11 and 12, defining a compartment 14 therebetween. At least one of the first end wall 11, the second end wall 12, and the peripheral wall 13 can be detached. In this example, the housing 1 includes an outer periphery providing a sealed member. The housing 1 includes at least one vent 15 in the first end wall 11 or the second end wall 12. The housing 1 can include a casing 16 at a bottom side of the first end wall 11. The casing 16 includes at least one vent 17.

The electric motor 2 includes a fixed seat 22 fixed to the first end wall 11 and located in the compartment 14. The electric motor 2 further includes a shaft 21 extending perpendicularly to and rotatably mounted to the fixed seat 22. The electric motor 2 further includes a first stator 23 fixed on the fixed seat 22 and a first rotor 24 fixed to the shaft 21. The first stator 23 and the first rotor 24 are concentrically mounted around the shaft 21. In this example, the first rotor 24 of the electric motor 2 is located around and spaced from the first stator 23. A first stator seat 25 extends upwards from an intermediate portion of the fixed seat 22 and has an axial hole 251. The shaft 21 rotatably extends through the axial hole 251. The first stator 23 is fixed around the first stator seat 25. A first rotor seat 26 is fixed around the first rotor 24. The first rotor seat 26 includes an end 261 fixed to the shaft 21.

The first fan 3 is fixed to the shaft 21 and includes a plurality of blades 31 spaced from each other. The first fan 3 is located adjacent to the second end wall 12 and faces the first end wall 11 for delivering wind power.

The generator 4 is concentrically mounted around the electric motor 2. The generator 4 includes a second stator 41 fixed to the fixed seat 22 and a second rotor 42 rotatably mounted to the shaft 21 and concentric to the second stator 41. In this example, the second rotor 42 of the generator 4 is located around and spaced from the second stator 41. A second stator seat 43 extends upwards from the fixed seat 22 and extends around and is spaced from the first rotor 24. The second stator 41 is fixed around the second stator seat 43. A second rotor seat 44 is fixed around the second rotor 42. The second rotor seat 44 includes an end 441 rotatably mounted to the shaft 21 by a bearing 45.

The second fan 5 is fixed around the second rotor seat 44 of the second rotor 42. The second fan 5 includes a plurality of blades 51 spaced from each other. The second fan 5 is located adjacent to the first end wall 11 and faces the second end wall 12. The first and second fans 3 and 5 can have an identical shape. The first and second fans 3 and 5 are coaxial, opposite to each other, and adjacent to each other.

The power device 6 is mounted in the casing 16 of the housing 1. The power device 6 is electrically connected to the generator 4 and the electric motor 2. The power device 6 is adapted to supply electricity to the external electrical appliance 7. In this example, the power device 6 includes a charging controller 61, a rechargeable battery 62, and a voltage boost circuit 63. The charging controller 61 is electrically connected to the generator 4 and the rechargeable battery 62. The rechargeable battery 62 is electrically connected to the electric motor 2 and the voltage boost circuit 63. The voltage boost circuit 63 is adapted to be electrically connected to the external electrical appliance 7.

When the electric motor 2 is supplied with electricity from the rechargeable battery 62 of the power device 6 and operates for the first time, the first rotor 24 and the shaft 21 of the electric motor 2 drive the first fan 3 to rotate, generating wind power close to the second fan 5. The second fan 5 is driven to rotate by the wind power in the compartment 14 of the housing 1. Furthermore, the second fan 5 drives the second rotor 42 of the generator 4 to rotate, making the generator 4 continuously generate and supply electricity to the power device 6 and the electric motor 2, thereby keeping the electric motor 2 running to generate the wind power while the first fan 3 continuously using the wind power to drive the second fan 5 and the generator 4 to generate electricity. Thus, the power device 6 can continuously and stably output electricity to the external electrical appliance 7. As a result, the power supply can rapidly generate electricity at any time and place to prolong the service time of the external electrical appliance 7, avoiding closing down of the external electrical appliance 7 due to running out of electricity. The concentric arrangement of the electric motor 2 and the generator 4 makes the power supply compact, which is easy to manufacture and which reduces the manufacturing costs.

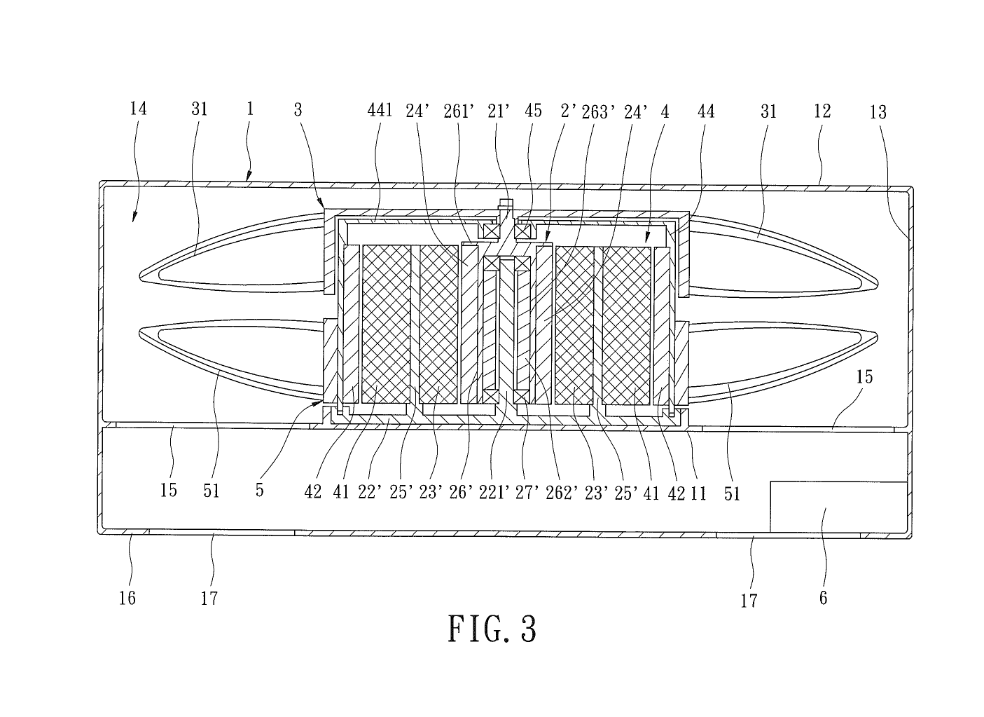

FIG. 3 shows a second example of the power supply. The second example is different from the first example by that the first stator 23′ of the electric motor 2′ is located around and spaced from the first rotor 24′. An axle 221′ extends upwards from an intermediate portion of the fixed seat 22′. A first rotor seat 26′ is fixed to an inner periphery of the first rotor 24′. The first rotor seat 26′ includes an end 261′ fixed to the shaft 21′. The first rotor seat 26′ further includes an axial hole 263′ extending downwards and receiving a sleeve 262′ and a bearing 27′, thereby rotatably receiving the axle 221′. A first stator seat 251′ extends upwards from the fixed seat 22′. The first stator 23′ is fixed to an inner periphery of the first stator seat 25′. In this example, the second rotor 42 of the generator 4 is located around and spaced from the second stator 41. The second stator 41 is directly fixed around the first stator seat 25′. A second rotor seat 44 is fixed around the second rotor 42. The second rotor seat 44 has an end 441 rotatably mounted to the shaft 21′. The second fan 5 is fixed around the second rotor seat 44.

When the electric motor 2′ is supplied with electricity from the power device 6 and operates for the first time, the first rotor 24′ and the shaft 21′ of the electric motor 2′ drive the first fan 3 to rotate, generating wind power close to the second fan 5. The second fan 5 is driven to rotate by the wind power in the compartment 14 of the housing 1. Furthermore, the second fan 5 drives the second rotor 42 of the generator 4 to rotate, making the generator 4 continuously generate and supply electricity to the power device 6 and the electric motor 2′, thereby keeping the electric motor 2′ running to generate the wind power while the first fan 3 continuously using the wind power to drive the second fan 5 and the generator 4 to generate electricity. Thus, the power device 6 can continuously and stably output electricity to the external electrical appliance 7.

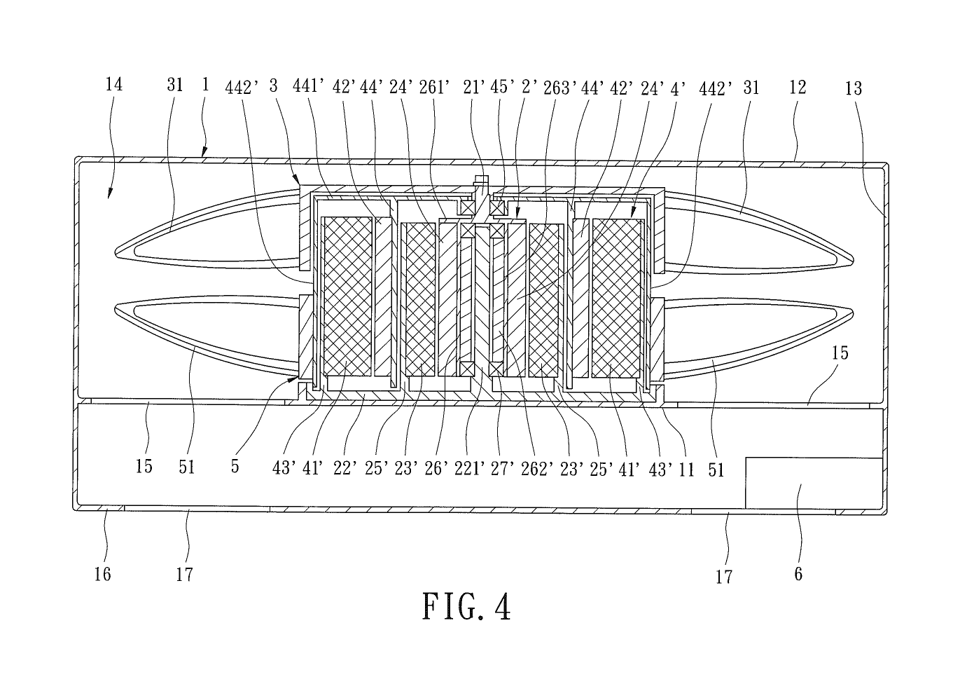

FIG. 4 show a third example of the power supply. The first stator 23′ and the first rotor 24′ of the electric motor 2′ of third example are the same of those of the second example. The third example is different from the first and second examples by that the second stator 41′ of the generator 4′ is located around and spaced from the second rotor 42′. A second stator seat 43′ extends upwards from the fixed seat 22′. The second stator 41′ is fixed to an inner periphery of the second stator seat 43′. A second rotor seat 44′ is fixed to an inner periphery of the second rotor 42′. The second rotor seat 44′ includes an end 441′ rotatably connected to the shaft 21′ by a bearing 45′. A cylindrical portion 442′ extends outwards from the end 441′ of the second rotor seat 44′ and surrounds the second stator seat 43′. The second fan 5 is fixed around the cylindrical portion 442′ of the second rotor seat 44′.

When the electric motor 2′ is supplied with electricity from the power device 6 and operates for the first time, the first rotor 24′ and the shaft 21′ of the electric motor 2′ drive the first fan 3 to rotate, generating wind power close to the second fan 5. The second fan 5 is driven to rotate by the wind power in the compartment 14 of the housing 1. Furthermore, the second fan 5 drives the second rotor 42′ of the generator 4′ to rotate, making the generator 4′ continuously generate and supply electricity to the power device 6 and the electric motor 2′, thereby keeping the electric motor 2′ running to generate the wind power while the first fan 3 continuously using the wind power to drive the second fan 5 and the generator 4′ to generate electricity. Thus, the power device 6 can continuously and stably output electricity to the external electrical appliance 7.

Although specific embodiments have been illustrated and described, numerous modifications and variations are still possible without departing from the scope of the invention. The scope of the invention is limited by the accompanying claims.

1. A power supply comprising:
a housing including a first end wall, a second end wall, and a peripheral wall interconnected between the first and second end walls, defining a compartment therebetween;
an electric motor including a fixed seat fixed to the first end wall and located in the compartment, with the electric motor further including a shaft extending perpendicularly to and rotatably mounted to the fixed seat, with the electric motor further including a first stator fixed on the fixed seat and a first rotor fixed to the shaft, and with the first stator and the first rotor concentrically mounted around the shaft;
a first fan fixed to the shaft, with the first fan located adjacent to the second end wall and facing the first end wall;
a generator concentrically mounted around the electric motor, with the generator including a second stator fixed to the fixed seat and a second rotor rotatably mounted to the shaft and concentric to the second stator;
a second fan fixed around the second rotor, with the second fan located adjacent to the first end wall and facing the second end wall, with the first and second fans being coaxial, opposite to each other, and adjacent to each other; and
a power device mounted to the housing, with the power device electrically connected to the generator and the electric motor, and with the power device adapted to supply electricity to an outside,
wherein when the electric motor is supplied with electricity from the power device and operates, the first rotor and the shaft of the electric motor drive the first fan to rotate, generating wind power close to the second fan, wherein the second fan is driven to rotate by the wind power in the compartment of the housing, with the second fan driving the second rotor of the generator to rotate, making the generator continuously generate and supply electricity to the power device and the electric motor, thereby keeping the electric motor running, and wherein the power device is adapted to output electricity to an external electrical appliance.

2. The power supply as claimed in claim 1, with the first rotor of the electric motor located around and spaced from the first stator, with a first stator seat extending upwards from an intermediate portion of the fixed seat and having an axial hole, with the shaft rotatably extending through the axial hole, with the first stator fixed around the first stator seat, with a first rotor seat fixed around the first rotor, and with the first rotor seat including an end fixed to the shaft.

3. The power supply as claimed in claim 2, with the second rotor of the generator located around and spaced from the second stator, with a second stator seat extending upwards from the fixed seat and extending around and spaced from the first rotor, with the second stator fixed around the second stator seat, with a second rotor seat fixed around the second rotor, with the second rotor seat including an end rotatably mounted to the shaft, and with the second fan fixed around the second rotor seat.

4. The power supply as claimed in claim 1, with the first stator of the electric motor located around and spaced from the first rotor, with an axle extending upwards from an intermediate portion of the fixed seat, with a first rotor seat fixed to an inner periphery of the first rotor, with the first rotor seat including an end fixed to the shaft, with the first rotor seat further including an axial hole extending downwards and rotatably receiving the axle, with a first stator seat extending upwards from the fixed seat, and with the first stator fixed to an inner periphery of the first stator seat.

5. The power supply as claimed in claim 4, with the second rotor of the generator located around and spaced from the second stator, with the second stator fixed around the first stator seat, with a second rotor seat fixed around the second rotor, with the second rotor seat having an end rotatably mounted to the shaft, and with the second fan fixed around the second rotor seat.

6. The power supply as claimed in claim 4, with the second stator of the generator located around and spaced from the second rotor, with a second stator seat extending upwards from the fixed seat, with the second stator fixed to an inner periphery of the second stator seat, with a second rotor seat fixed to an inner periphery of the second rotor, with the second rotor seat including an end rotatably connected to the shaft, with a cylindrical portion extending outwards from the end of the second rotor seat and surrounding the second stator seat, and with the second fan fixed around the cylindrical portion of the second rotor seat.

7. The power supply as claimed in claim 1, with the housing including an outer periphery providing a sealed member, with the housing including at least one vent in the first end wall.

8. The power supply as claimed in claim 1, with the power device including a charging controller, a rechargeable battery, and a voltage boost circuit, with the charging controller electrically connected to the generator and the rechargeable battery, with the rechargeable battery electrically connected to the electric motor and the voltage boost circuit, and with the voltage boost circuit adapted to be electrically connected to the external electrical appliance.

9. The power supply as claimed in claim 8, with the housing including a casing at a bottom side of the first end wall, with the casing including a vent, and with the power device mounted in the casing.
